(19) United States
(12) Patent Application Publication
(10) Pub. No.: US 2007/0233782 A1
(43) Pub. Date: Oct. 4, 2007

(54) METHOD & SYSTEM FOR ACQUIRING, STORING, & MANAGING SOFTWARE APPLICATIONS VIA A COMMUNICATIONS NETWORK

(75) Inventor: Tarik Tali, Emerald Hills, CA (US)

Correspondence Address: KEEVICAN WEISS BAUERLE & HIRSCH LLC;(FORMERLY KNOWN AS DKW LAW GROUP LLC), 11TH FLOOR, FEDERATED INVESTORS TOWER, 1001 LIBERTY AVENUE, PITTSBURGH, PA, 15222, US

(73) Assignee: SILENTCLICK, INC., REDWOOD CITY, CA (US)

(21) Appl. No.: 11/692,438

(22) Filed: Mar. 28, 2007

Related U.S. Application Data
(60) Provisional application No. 60/743,845, filed on Mar. 28, 2006.

(51) Int. Cl. G06F 15/16; G06F 15/177

(52) U.S. Cl. 709/203; 709/220

(57) ABSTRACT

A comprehensive software storage and management method and system includes a storage network and an online, preferably web2.0 software application, which allows the user(s) to store and manage their software applications over the network for any digital device that communicates with the Internet, whether mobile or non-mobile, and whether or not the device is wireless. The application will allow the user(s) to view, manage, upload, download and install any of their available, and to be acquired, software applications over the Internet at anytime via an Internet Connection. The system provides a “one button” upload of new software applications, “one button” download existing or acquired software applications, automatic software authentication for the users and/or vendors, and many other software management options.

The present invention claims priority of U.S. Provisional Patent Application Ser. No. 60/743,845 entitled “Method and System for Acquiring, Storing and Managing Software Applications Via a Communications Network” invented by Tarik M. Tali and filed Mar. 28, 2006, and to U.S. Provisional Patent Application Ser. No. 60/826,733 entitled “Personal Software Portal Providing a Method and System for Acquiring, Storing and Managing Software Applications Via a Communications Network” also invented by Tarik M. Tali and filed Sep. 22, 2006.

### BACKGROUND OF THE INVENTION

1. Field of the Invention

The present invention relates to a method and system for comprehensive software management. More particularly, the present invention is directed to a method and system in which a host computer(s), server(s) or similar device(s) (the host network) and a personal computer or similar device that are in communication with each other over a computer communications network, such as the Internet, cooperate with each other to cause the host network to store, acquire, and/or manage, in whole or in part, the applications software that is needed to operate, or at least associated with, the personal computer. Functions of the method and system of the present invention include but are not limited to one or more of viewing the user's entire software library, printing list of entire software library, uploading, downloading, storing, installing, acquiring, managing, recovering/restoring, sharing, rating, transferring, updating, upgrading, downgrading and/or authenticating the applications software, including managing licenses and/or software keys related thereto, for the applications software used to operate, or associated with, the PC or similar device. In a preferred embodiment of the present invention, one or more of these functions are accomplished with minimal user input, and still more preferably are accomplished with a single keystroke or mouse click by the user.

2. Background Information

On-line data back up providers are well known options for personal computer (“PC”) users to back up hard drives. Typical examples are operated by companies such as Data Deposit Box, Carbonite, Iron Mountain, US Data Trust, Ibackup, Amerivault, Backup Solutions, Corilium, Backup Direct, Glide and others. These online data storage systems typically provide a snapshot of a PC hard drive at a given point in time that is useful for selective or total system recovery, but provides little or no software management to the users, particularly for the applications software that is needed to operate the PC.

There are also companies offering network attached storage (“NAS”), in which stored files are accessed over a network. Current NAS systems are relatively expensive and not particularly user friendly. The existing systems do not provide for comprehensive and efficient software management for the users, again, particularly for the applications software that is needed to operate a PC.

Google Inc., has proposed a “GDrive” product that is believed to be intended to decouple a PC user's hardware from the data stored on the hardware in an effort to form a “virtual hard drive” for the PC, with the D Gdrive product being described as having the capability that already exists among online backup providers such as Data Deposit Box and Carbonite. The proposed technology apparently involves a small program that runs on a user's PC and monitors changes made to targeted files. The program backs up the files to a secure site on the Internet every time changes are made to them. Again there does not appear to be any significant management of the applications software necessary to operate the PC offered to the PC user through this proposed system. Some have expressed privacy concerns about such a system.

LogMeIn Inc., (apparently a play on the words “log me in”) offers a suite of remote access and support products such as LogMeIn Reach, LogMeIn Rescue, LogMeIn Backup for example, that LogMeIn Inc., states provides secure connections between remote PCs over the Internet. The service has applications for desktop remote control, data backup, file sharing, remote system administration, and on-demand customer support. Similar remote access systems are available from Citrix Online LLC with its product sold under the mark GoToMyPC®, but these systems simply provide a gateway to access ones existing PC from a remote location (e.g. work at home solutions). These gateways do not provide any software storage or any significant applications software management options.

An applications service provider (“ASP”) is an organization that hosts software applications on its own servers within its own facilities. Customers effectively rent the use of the application and access it over the Internet or via a private line connection. This system is also called a “commercial service provider.” The Web browser, acting as a universal client interface, has fueled this “on-demand software” market. The ASP is actually distinguished from Web hosting, as the latter merely entails making (and managing) a Web site available on the Internet for a third party.

Many internet service providers (“ISPs”) host a few personal web pages for an individual at no additional cost above the monthly service fee, but the address is subordinate to the ISP. Others have argued that ASPs do not fundamentally change the architecture of their software applications market, but simply resell legacy applications to organizations that did not want to house them on their own computer systems. These deficiencies have lead to a new breed of Web-based services that are pushing legacy applications aside and finally giving users the business benefits they have been seeking.

This new form of software-as-a-service (“SaaS”), is somewhat represented by the services provided by the Salesforce.com company as may be viewed at its Web site at www.salesforce.com. Offered there is a customer relationship management and sales force automation application. Netsuite Inc., offers a similar service with its “net-native” enterprise resource planning applications as may be viewed at its Web site at www.netsuite.com.

SaaS generally recognizes the inherent inefficiencies of the traditional software market, including the tremendous time, effort, and cost that organizations—especially large-scale to mid-sized business have to expend to install application software, and keep it properly licensed, updated and running.

Despite the success of these companies, many are still skeptical about the long-term success of SaaS. Regardless, a rapidly growing directory of SaaS companies can be seen at saas-showplace.com. Many companies now consider various information technology (“IT”) functions and business applications as commodities and not core competencies. This has made SaaS essentially an outsourced application management business, more attractive today than ASPs and hosting services of the past. Many SaaS applications can eliminate the need for additional IT infrastructure investments to support new applications.

A variety of enabling technologies, such as service-oriented architecture and Web services, permit SaaS to be more easily provisioned and metered based on actual usage levels. This means companies no longer have to pay for excess capacity. This results in lower total cost of ownership and quicker time-to-value. Companies of all sizes may take advantage of SaaS applications. The scalability of the new generation of SaaS solutions enables users to test the reliability and performance of on-demand applications in limited deployments, and expand their adoption incrementally.

Some believe that that the coming “services wave” may be disruptive as SaaS scales up to service tens or hundreds of millions, and that this will dramatically change the nature and cost of solutions deliverable to enterprises or small businesses. It has been asserted that nearly every established software vendor is being forced to determine how to revamp their legacy application business models to join the SaaS movement. This is not a small challenge. It has been suggested that legacy software companies will have to re-architect their applications to make them work on the Web and they will have to redesign their sales and financial models, and they will have to rebuild their corporate cultures to make them more service-oriented rather than product-centric. There is clearly a need for a SaaS solution that more easily accommodates current software company structures to avoid radical company realignments.

Individuals and small businesses as well as large-scale or mid-sized operations are also impacted by these changes. Individual consumers and small businesses suffer from the same software inefficiencies. The inherent inefficiencies of the traditional software market, including the tremendous time, effort and cost expended to install applications and keep them licensed and updated and running may be considered more onerous due to the lack of resources to direct to such matters. Individual consumers and small businesses may be considered to be even more demanding of cost effective, easily portable computer services than the large-scale or mid-sized operations. The boon in laptop computers only evidences the need. Portable computers, despite improvements in the last few years, do not satisfy this requirement.

There remains a need for an easy to use, easy to access, efficient, comprehensive method and system for the storage, acquisition and management of the applications software associated with and, in particular, needed to operate PCs and similar digital devices connected to the Internet.

It is an object of the present invention to address the deficiencies of the prior art discussed above and to do so in an efficient, cost effective manner.

### SUMMARY OF THE INVENTION

The various embodiments and examples of the present invention as presented herein are understood to be illustrative of the present invention and not restrictive thereof and are non-limiting with respect to the scope of the invention.

According to one non-limiting embodiment of the present invention, a method, system and/or software application is provided, preferably a web2.0 compatible software application, which allows the user(s) of PCs and similar devices to store and manage their applications software over a computer communications network, such as the Internet. This may include the use of a personal software portal. Functions accomplished by the method, system and/or software of the present invention include but are not limited to one or more of viewing the user's entire software library, printing lists of the user's entire software library, uploading, downloading, storing, installing, acquiring, managing, recovering/restoring, sharing, rating, transferring, updating, upgrading, downgrading and/or authenticating the applications software, including managing licenses and/or software keys related thereto, for the applications software used to operate the PC or similar device. In a preferred embodiment of the present invention, one or more of these functions are accomplished with minimal user input, and still more preferably are accomplished with a single keystroke or mouse click by the user. It is also within the scope of the invention to have the user selectively identify which applications will be available for one click uploading, downloading, recovery/restoring and the like within this system.

The present invention will allow the user(s) of PCs and/or similar devices to manage any of their available, and/or to be acquired, software applications over the Internet at anytime with any Internet capable device via an Internet connection.

In one non-limiting aspect of the present invention, an application termed the Software Management Utility, manages the user's security access to each software vendor library and manages the user's licenses pertaining to each software application he/she has downloaded/uploaded. The Software Management Utility manages the user's Serial Numbers pertaining to each software application he/she has downloaded and also manages the user-to-vendor's serial number(s) authentication(s).

In one non-limiting aspect of the present invention, the Software Management Utility records the software installation input prompts inputted by the user for each software application the user installs in his/her PC.

In one non-limiting aspect of the present invention, the Software Management Utility streams and overlays those previously recorded input prompts of the user during the re-installation for each software installation the user is performing for the second or other additional time so that the user does not have to provide those inputs again, allowing the software to re-install automatically or with very little input from the user.

In one non-limiting aspect of the present invention, the Software Management Utility allows the user to perform one click software upgrades to new software release and upgrades.

In one non-limiting aspect of the present invention, the Software Management Utility allows the user to perform one click software downgrade to previous versions(s) and software release(s).

In one non-limiting aspect of the present invention, the Software Management Utility manages “vendor-to-client” software Authentication for a single, and or multiple application(s) software for install during the install to a PC.

In one non-limiting aspect of the present invention, the Software Management Utility provides a “vendor-to-client” direct link and/or a Peer-to-Peer link between a software vendor and the user's PC.

In one non-limiting aspect of the present invention, the Software Management Utility “vendor-to-client” peer-to-peer link allows the software vendor to offer or provide to the user various services/products, including but not limited to advising the user of sales promotions, new products, special discounts, fixes, upgrades and the like.

The present invention provides a method and system for a Software Social Networking Utility engine. The Software Social Networking Utility allows the user(s) to easily build and share their software favorites with their friends and family and others.

The present invention provides a method and system for the user's to transfer programs they no longer need to another and, optionally but preferably provides for the management of the software license and/or any needed software key transfer.

In one non-limiting aspect of the present invention, the Software Management Utility provides for software disaster and recovery alerts to be presented to the user(s) where warranted, including but not limited to where software has been deleted by accident, or corrupted for example by accidental deletion of one or more shared dynamic link library (“DLL”) files when an uninstall or removal of the software took place or from virus attacks, etc.

In one embodiment, the present invention provides a software performance ranking system which yields a personal software index or score to all the software(s) that the user(s) have installed in their PC. In one non-limiting aspect of the present invention, the Software Management Utility compiles the software rankings of each of a plurality of users, also called members, and generates an overall ranking index for the entire membership about all the software that the users have installed in their PC. Unlike other software ranking systems which are based on the number of downloads for each software application and user's feed back, the current rating index is based on real time actual computational performances of the software, its use and its stability over time.

In one non-limiting aspect of the present invention, the Software Management Utility allows for an easy to use mashup platform software utility which collapses several service layers/packets into one packet stream under an easy to use user interface. The layers are not limited to the software management layer, the vendors-to-clients software layer, the social network layer; and/or the software disaster and recovery layer, but can include other layers known or hereinafter developed by those skilled in the art.

These and other advantages of the present invention will be clarified in the description of the preferred embodiments taken together with the attached figures.

### BRIEF DESCRIPTION OF THE DRAWINGS

FIG. 1 is a schematic representation of the operation of the web based system for software application storage, acquisition and management including forming a personal software portal according to the present invention.

FIG. 2 is a schematic representation of the Software Management Mashup Utility of the present invention.

FIG. 3 is schematic representation of the Software Management Layer of the present invention.

FIG. 4 is a schematic representation of the software upload process of the Software Management Layer of the present invention.

FIG. 5 is a Graphical User Interface relating to the software upload process of the present invention.

FIG. 6 is a schematic representation of the software download process of the Software Management Layer of the present invention.

FIG. 7 is a schematic representation of the serial keys upload process of the Software Management Layer of the present invention.

FIG. 8 is a schematic layer representing the Software Installations Screen Prompts Capture and Upload Process.

FIG. 9 is a Graphical User Interface relating to upgrades for the present invention.

FIG. 10 is a Graphical User Interface relating to a promotional software offer from a vendor for the present invention.

FIG. 11 is a schematic representation of the Software Performance Layer of the present invention.

FIG. 12 is a schematic representation of the Software Performance Ranking Process of the present invention.

FIG. 13 is a schematic representation of the Software Disaster Recovery Layer of the present invention.

FIG. 14 is a schematic representation of the software recovery and silent prompts sequencing process of the Software Disaster and Recovery Layer of the present invention.

FIG. 15 is a Graphical User Interface illustrating the warning of an unstable software program.

FIG. 16 is a schematic representation of the software downgrade process and prompts sequencing overlay process of the Software Disaster and Recovery Layer of the present invention.

FIG. 17 is a schematic representation of the Software Publishing Layer of the present invention.

FIG. 18 is a schematic representation of a live “add push” of the present invention.

FIG. 19 is a schematic representation of the Software Publishing Layer of the present invention.

FIG. 20 is a schematic representation of the Software Social Network Layer of the present invention.

FIG. 21 is a schematic representation of the Software Social Network Layer of the present invention.

FIG. 22 is a schematic representation of Al process flow chart.

FIG. 23 is a schematic representation of the mobile to mobile and mobile to desktop Software management layer.

FIG. 24 is a schematic representation of a Software Transfer Management Layer according to one aspect of the present invention illustrating a transfer of a software license key from one system user to another system user.

### DESCRIPTION OF THE PREFERRED EMBODIMENTS

The terms “user”, “customer”, “member” and “client” will be effectively interchangeable within this application unless otherwise clear from the context.

The term “vendor” will generally reference third party sources of software and associated updates unless otherwise clear from the context. The vendor need not be the originator of the software applications or updates thereto.

The phrases “applications software” or “software applications” have been defined by some to mean programs or sets of programs designed to perform specific user-oriented functions. Alternatively it may be understood to refer to software that is necessary to cause the PC or other digital device to perform operations required/desired by the user. Examples of applications software include operating systems such as Microsoft's Inc.'s Windows® operating system or software to perform various functions such as word processing (e.g. Microsoft's Word® or Corel Corporations Wordperfect® word processing programs), and free to use software or what is commonly known as Freeware where no license is required for the software to be used (e.g. over the Internet phone communication software Skype or Google Talk). There are literally millions of such applications software available today, and it will be assumed that the term “applications software” is easily understood by nearly all by this time.

SilentClick, Inc., (“SilentClick”) is the assignee of this application, and was formerly Thin Objects, Inc., (“ThinObjects”). Where the terms “SilentClick” or “ThinObject(s)” appear in this specification or its drawings, the terms are referring to these entities or to the present invention or components of it, as will be clear from the context. It will be evident that the use of Silent Click and/or ThinObjects is not intended to be restrictive to these entities that are merely representative of the implementation of the present invention.

In the foregoing and following discussion, the term “PC” or “digital device” has predominantly been used for convenience, but to be clear, as may be appreciated, the present invention is not limited to PCs. Any digital device that utilizes application software and communicates, wirelessly or tethered, over a computer network such as the Internet is within the scope of the present invention. Examples within the scope of the present invention include but certainly are not limited to desk top PCs, portable PCs, notebook computers, set-top-box, digital televisions, personal digital assistants (“PDAs”), palm pilots, cell telephones, smart phones and any similar digital devices and combinations thereof now known or hereinafter developed that use application software and communicate over one or more computer network(s) such as the Internet.

The term “Internet” is employed in the foregoing and following discussion to refer to a communications network and the term is used in its ordinary context, but it must be understood that the present invention is not limited to the Internet, and will function over any network of communicating computers. However, for the sake of convenience, the following discussion will simply use the term Internet.

The term “one button” within the meaning of the present invention represents a user interface requiring a single mouse click, a single keystroke, or other single data input mechanism to launch or undertake the designated action.

The present invention, very generally speaking, may be considered to be comprised of several components. Thus one aspect of the present invention is each of the inventive components, while another aspect of the present invention is the combination of one or more of those components, and yet another aspect of the present invention is the combination of all of the components.

As may be appreciated then, the present invention may be described by beginning with a description of each of the components individually and by then describing the combination of one or more, or all, of the components. Alternatively, the present invention may be described by beginning with a description of the combination of components, followed by a description of each of the components. The latter approach has been taken to describe the present invention.

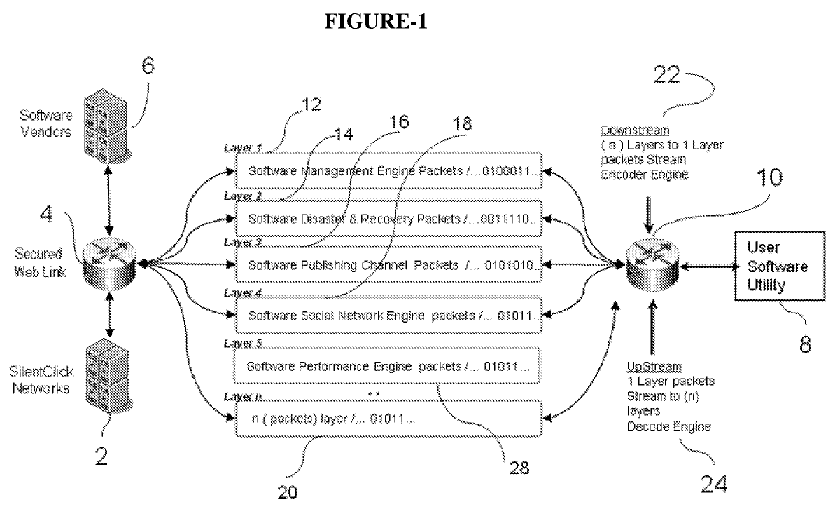

Referring now to FIG. 1, there is illustrated a schematic representation of the collection of components of the present invention.

The SilentClick or host network 2 of the present invention communicates via a secure Web link 4 with software vendor 6 and with a user's PC 8, which is labeled as “user software utility” in FIG. 1, via another link 10, providing functionality in layers or packets as next described. The network 2 is a collection of one or more interconnected host computers, servers or the like as known in the art.

The layers of the present invention include a Software Management Engine Layer/Packet 12, a Software Disaster and Recovery Layer/Packet 14, a Software Publishing Channel Layer/Packet 16, a Software Social Network Engine Layer/Packet 18 and a Software Performance Engine Layer/Packet 28. The present invention is not limited to Layers 12, 14, 16, 18 and 28, and as may be appreciated, where more functionality is desired or required, more layers may be employed. Therefore, as shown in FIG. 1, any number of additional layers 20 as represented by the integer “n” may be added as within the scope of the present invention.

As indicated in FIG. 1, in a downstream direction, that is to say in a direction flowing from the SilentClick networks 2 to the user's PC 8, the several layers of the present invention are combined or “mashed” into a single layer by downstream encoder engine 22. In an upstream direction, that is to say in a direction from the user's PC 8 to SilentClick networks 2, a single layer is streamed to “n” layers by decoder engine 24.

In essence, application software that is needed to operate on PC 8 either (i) is resident on SilentClick network 2 or (ii) is uploaded from PC 8 to the SilentClick's network 2, or (iii) is resident on at the software vendor 6 with appropriate access and authentication on the host associated with specific users. In each case the application software of a user is managed by the SilentClick network 2 via one or more of the layers 12, 14, 16, 18, 20 and 28.

FIG. 1 schematically illustrates a method and system according to the present invention which effectively: (i) performs an over-the-Internet storage of software from a user(s) PC to a private communications network, namely the SilentClick hosting network 2; (ii) performs an over the internet, real time, expedited software acquisition for the user; (iii) performs automated, user friendly comprehensive management (updates, authentication, etc.) of the personal software for the user; and (iv) improves vendor/software client interactions. The personal software access portal method and system according to the present invention is a unique implementation of the Software as a Service (SaaS) model for software application and management which also effectively provides for online data storage and backup. The service provider in the method and system according to the present invention operates the private communications network 2 that supports the system. The private communications network 2 is coupled to the Internet to receive input from clients and to communicate with vendors. The private communications network 2 may be formed in a conventional fashion and may be formed with redundancies or even as a collection of independent networks coupled together, such as via Internet connections.

The mechanics of online data storage are well known from existing on-line data backup providers. But the present invention relates to far more than simple data backup. The present invention provides a comprehensive on-line software management solution for applications software. In one embodiment, the present invention provides an Internet based software management process executed via the Software Management Utility Layer 12 that allows users to upload, via the Internet, any existing software application for storage and management to private communications network or hosting 2.

The application software that is to be stored on the private communications network 2 may be in various physical mediums and formats such as on the user's hard drive, a compact disc, a memory device or other storage medium that may be read, then formatted to an appropriate transport standard packet format(s), then loaded and transferred from the PC 8, over the Internet to the private network 2 for storage and management by the present invention.

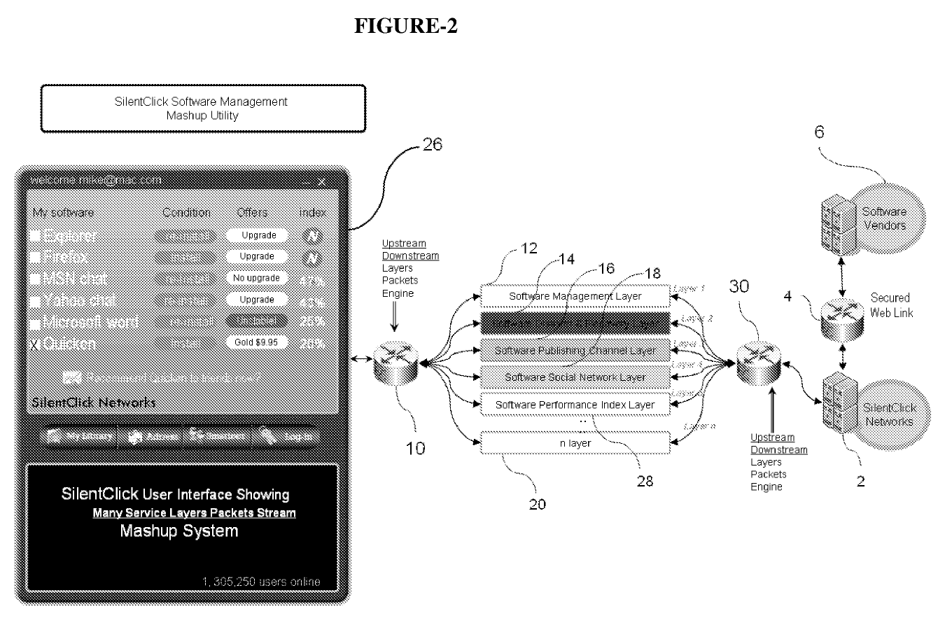

Referring now to FIG. 2, there is shown a graphical user interface (“GUI”) 26 that is employed to allow the user of the PC 8 to interface with the private communications network 2 of the present invention. In FIG. 2 as with all figures in this application, like elements bear the same reference numerals. Thus, layers 12-20 are as described in connection with FIG. 1. Additional link 30 is also shown in FIG. 2.

As may be seen in FIG. 2, there is provided the “SilentClick Software Management Mashup Utility. A “mashup” is a term that is broadly used and is capable of several meanings, but some have defined it to mean creating a new work by combining elements of two or more existing works. In the context of the present invention, the mashup is provided by the SilentClick Software Mashup Utility, which as represented by layers 12-20 and 28 and GUI 26, provides the user with several functionalities.

The inventor believes that it is an important aspect of the present invention, that these functionalities are presented in a very clear, simple and easy to use and understand manner in the GUI 26. This is particularly useful for users who are not IT professionals and simply want a non-complex method, system and environment to accomplish these functions. This is very novel and nothing is known that presents these functionalities in such an easy to use format.

This is clearly exemplified on GUI 26. There the user has his or her applications software listed, a condition advises them whether to install or re-install the software. Also shown are offers from software vendors regarding whether upgrades are available or not, as well as whether, as in the case of Microsoft Word shown on GUI 26, the applications software has become unstable. An index ranking advised the user about the popularity of the software as described in more detail herein below including providing percentages in such index. There is provided a mechanism to recommend software to friends, family or others, as shown in connection with the suggestion to recommend Quicken to friends.

Other functionality is provided such as “My Library”, “Address”, “Smarteez” and “Log-in” as shown in FIG. 2. “My Library” provides the user with a one click method to view the software in the user's library. “Address” provides the user with his list of email addresses of friends, family and others. “Smarteez” provides a one click method and system for a user to send software to friends, family or others, whether or not those friends, family or others have joined the SilentClick network. In operation, after clicking on “Smarteez” the user is provided with a list of software that the user can legally send to another, such as freeware, shareware, free trials of licensable software etc. Smarteez, in a preferred embodiment, does not provide the user with any software the use cannot lawfully transfer to another. The user can then send an email generated by the present invention to one or more recipients that the user wishes to receive it that notifies the recipient that the user has made them a gift of such software. The recipient is also provided at the same time with a link to SilentClick, and upon joining the SilentClick network, the recipient can accept or decline the software, whereupon, if accepted, the software will be deposited in the recipient's library in the SilentClick network.

It is important to appreciate that the precise layout of GUI 26, and the other GUIs described herein, are not limiting to the present invention, and any similar arrangement of GUI elements may be employed to provide the functionality of the present invention. That is to say buttons can be larger or smaller or placed differently on the GUI or color schemes may be changed, in short any of the elements may be varied and remain within the scope of the present invention provided the resulting GUI provides the functionality of the present invention.

The functionality shown on GUI 26 is provided via layers 12-20 and 28 associated via line 30 with SilentClick network 2. While not every function has been illustrated in FIG. 2, functions that may be provided by this arrangement by the present invention include but are not limited to one or more of viewing the user's entire software library, printing list of entire software library, uploading, downloading, storing, installing, acquiring, managing, recovering/restoring, sharing, rating, transferring, updating, upgrading, downgrading and/or authenticating the applications software, including managing licenses and/or software keys related thereto.

In one embodiment, the present invention provides a “One Button” upload method and system to effectively perform the several functions, such as the over-the-Internet storage of software to the private communications network 2 as shown by the screen buttons such as “install”, “re-install”, “upgrade” etc. in FIG. 2. As stated above, the term “one button” within the meaning of this specification, represents a user interface requiring a single mouse click, a single keystroke, or other single data input mechanism to launch or undertake the designated action. The user interface with the present invention will allow the user to identify the subject software and with a single click, or other one button input, perform the desired function, e.g. upload the subject software or software application to the private communications network 2, for example. It is believed the foregoing will provide a useful overview of the present invention to form the basis for understanding the interplay of its various component parts. What follows then is a more detailed discussion of some of those components.

### The Software Management Layer

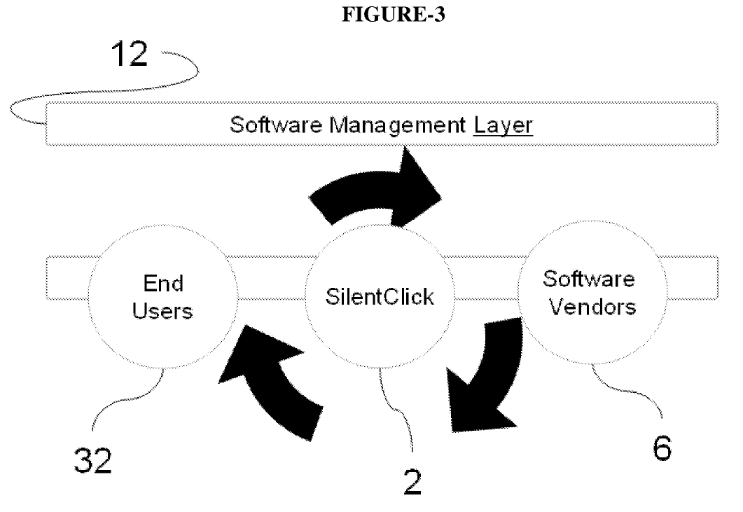

The Software Management Utility Layer 12 is one of the key components of the present invention. Referring now to FIG. 3, there is shown the interface of the Software Management Layer 12 provided by the network 2 to both software vendors 6 and end users 32.

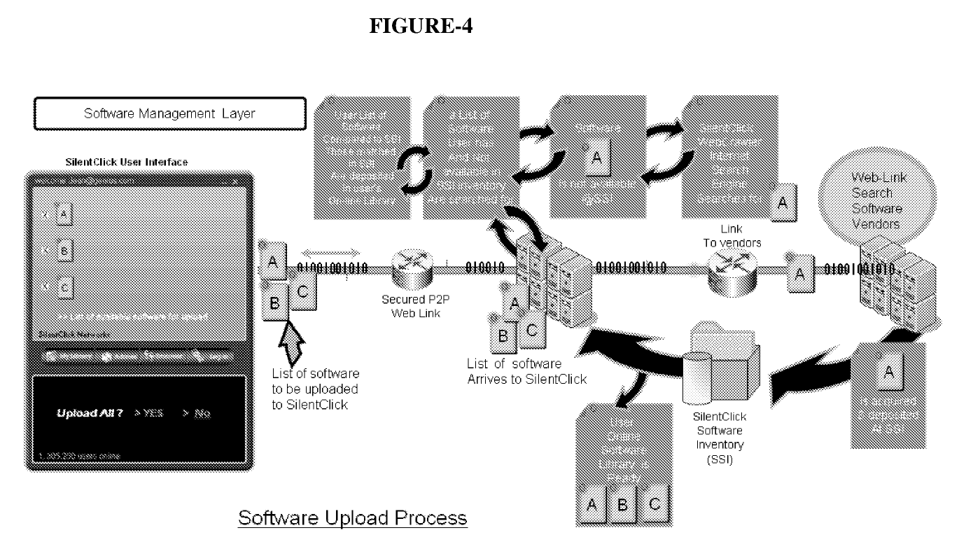

The Software Management Utility Layer 12 provides over the Internet, for example, the efficient upload of existing software that is available and resident inside a user's PC. As shown in FIG. 4, the software applications will be read, then formatted to associated transport standard packet format(s), then loaded and transferred over the Internet for storage and management to the private communications network 2.

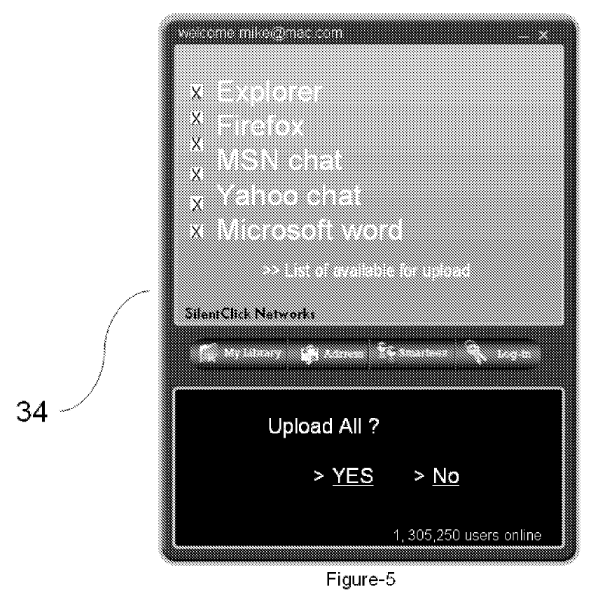

Referring to FIG. 5, the Software Management Utility Layer 12 may include GUI 34. GUI 34 allows the user to easily select which applications software the user wants to upload to the network 2 simply by, in this case, using “x” boxes to select the desired software. Upload is then accomplished simply by a single click in response to the “Upload all?” question.

The present invention provides a method and system for the Software Management Utility to manage the user's software residing inside his/her multiple digital device(s). Silent Click software management utility automatically manages the software belonging to the user for each digital device(s), i.e., Personal Computer, Set-Top-box, Digital TV, PDA and Smart Phones devices. SilentClick stores each digital device ID during the user's sign-up, and or registration. SilentClick maintains a table index which holds each digital device and its ID that the user has registered with SilentClick. The software applications inside each digital device are scanned and transferred and uploaded using SilentClick's one click upload method over the Internet, to be stored and managed by the private communications network 2. SilentClick Software Management Utility automatically detects each time the user logs in and what digital device is actually connected to the networks, i.e. via Desktop, Laptop or PDA/smart device and manages each device's software belonging to the user(s) as previously discussed. SilentClick will then service and manage the software pertaining to the digital device the user has used to connect to SilentClick Networks with.

The present invention provides an artificial intelligence engine (“Al”) to manage, track, and record the user's software movement(s) or activities inside his/her digital device. The SilentClick artificial intelligence engine is a client application which resides inside the user's digital device. The user's software movement(s) data or activities are captured by the artificial intelligence engine and recorded in a file inside the user's digital device which are then transmitted back securely to the SilentClick networks 2 and stored in the user's personal software tracking table. The user's software tracking table data transmission updates from the user's digital device (e.g. the user's PC) to SilentClick networks 2 each time the user connects his or her digital device (e.g. PC) to the internet or is on-line. The software movement(s) and or its activities tracking are repeated for each software program or application residing in the user's digital device(s).

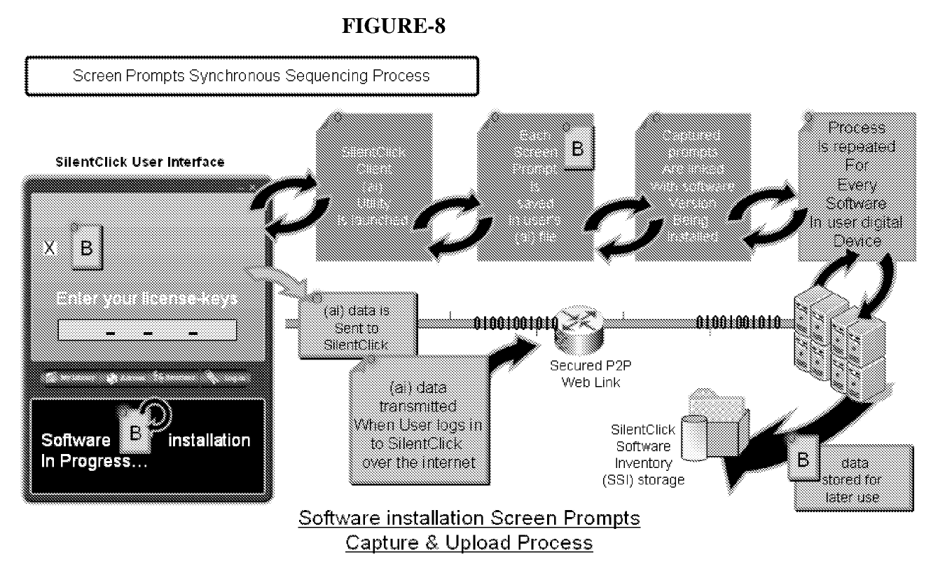

The present invention also provides an artificial intelligence engine (“AI”) to manage, track, and record the user's inputs data screen prompts for each software installation activity he/she performs inside his/her digital device as shown in FIG. 8. The Software Management Utility Layer 12 may include the GUI illustrated in FIG. 8. The GUI illustrated in FIG. 8 allows the user to easily select software programs for upload and storage within the SilentClick networks. During the upload of the software programs, AI will upload the recorded screen prompts associated with each software program the user has installed in his/her digital device. For example, in FIG. 8 the user will input a license key as requested by the GUI. That input is recorded and sent to the SilentClick network. When the user needs to reinstall that software, this prompt is provided by the Software Management Utility Layer 12 at the appropriate point in the re-installation of the software, so that the user does not have to input the license key again when reinstalling the software that originally requested the license key.

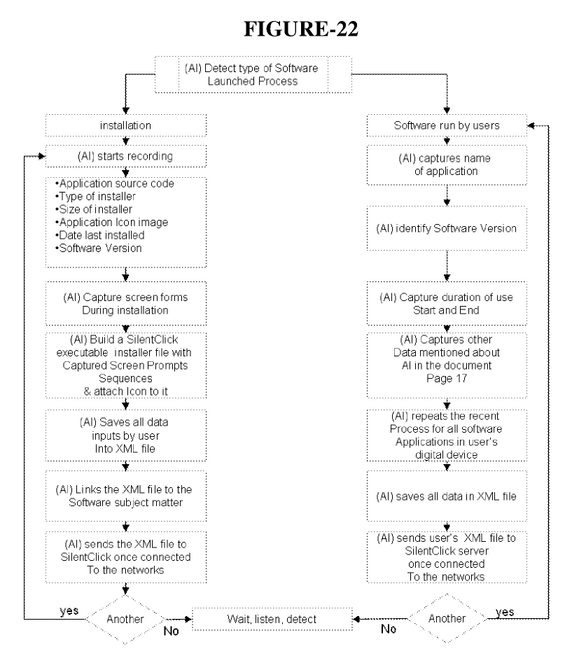

More particularly, the present invention provides a software installation screens prompts capture and upload to SilentClick networks as shown in FIG. 8. Once the AI client application is installed in the user's digital device, the AI will monitor for the instance a software installation is triggered. Once the installation is triggered the AI starts recording and/or capturing the user's data inputs. Data inputs are stored in XML file which are then later sent to SilentClick to update user's on-line software log as shown in FIG. 22.

The present invention provides an artificial intelligence engine (“AI”) resident as a client application in the user's digital device. The client application communications process is as follow and not limited to:
Client side:
1. AI scans digital device and acquires data
   a) List of unchanged application
   b) List of deleted, removed or uninstalled applications
   c) List of added and/or installed application
   d) List of captured input screen prompts data
   e) Other data . . .
   f) All captured data is saved in XML file in client side
   g) AI sends saved XML data to SilentClick server once connected to network
Server side:
1. The server processes user received software data
2. Server application adds & logs changes to every application
3. SilentClick conducts a search and match
4. If the software subject's matter executable source exist in SilentClick inventory and the subject matter is a license Free software
   a. Then the software is virtually deposited to the user's library by SilentClick from its SSI (software inventory)
   b. No actual physical software transfer occurs between SilentClick software inventory (SSI) and the user's on-line library, simply a pointer is added linking the software to the user making it available for future on-line download.
5. If the software application subject matter requires License-Keys, then:
   a. SilentClick uploads the serial keys associated with the software application in the case the scan engine has detected and located them
   b. In the case SilentClick has detected No license keys associated with the subject matter, SilentClick prompts the user to manually enter the serial keys data.
   c. All users' data are stored in SilentClick software storage vault.
   d. SilentClick connects to software vendors and requests license keys authentications and future user direct download of the software subject matter directly from the software vendors.
6. The server processes and updates the user's software library log and sends it back to the AI client application as an XML file to update the old one.

The AI engine performs the following functions: (A) AI detects and records the name of the software application being downloaded; (B) AI detects and records the revision or version release of the software; (C) AI records the software program's Installer Type (by capturing the installer extension type if it is an .Msi, Nulsoft, Wise, Inoo . . . + and or others); (D) AI tracks and records the location, folder, subfolder and or directory where the downloaded executable file, zipped or not zipped software package is placed. The executable file of the downloaded software file is then captured by AI and stored in a SilentClick folder inside the user's digital device; (E) AI detects and records whether the just downloaded and/or acquired software program is a freeware, shareware or purchased software and whether the software has a license-key. As shown in FIG. 8, if the software does have a license-key(s), and/or serial number(s), the user will input a license-key as requested by the GUI and the AI will also capture and add the data to each of the user's personal software license-keys table. That input is recorded and sent to the SilentClick network. When the user needs to reinstall that software, this prompt is provided by the Software Management Utility Layer 12 at the appropriate point in the re-installation of the software, so that the user does not have to input the license key again when reinstalling the software that originally requested the license key; (F) during the installation of the just acquired software program, the AI records all the data inputs typed by the user as he/she responds to the software programs installations prompt and/or input screens. All the inputs entered by the user are captured in an XML file and are later transmitted back to SilentClick networks 2; (G) the user's input, regarding the term-of-use and licenses agreements he or she has agreed upon during installation for use with each program is also captured; (H) all the inputs corresponding to each response to each software installation's prompts screens are compiled and are associated with each software program and is unique to each software program and version release; (I) the term “SilentClick” now takes on it's meant to be role and definition which is each time a user logs-in to his/her SilentClick software library and tries to install or re-install a software program that she/he installed before, on behalf of the user, the software installation prompt screens inputs data are sequenced-in automatically by SilentClick data filler look-up table transparently and thus speeding up then installation process. If the user chooses to install multiple programs simultaneously, the same process of ‘SilentClick’ takes place for each program queued to be installed and what ever agreement she/he has agreed up on in the first place will be used. This process then allows for SilentClick software management users to be able to perform the one button or one-click simultaneous install of all their programs and to take place without the intervention of the user at all saving a great amount of time and frustrations; (K) the AI also tracks each software that has been un-installed by the user from his/her digital device. This un-install or uninstall of software(s) data is also stored back at the SilentClick networks 2 customer software table for future reference; (L), after software has been installed and ready for use, the AI will also track and record each time an application is opened or launched by the user; how long or the duration of the use of the launched application; the connection-duration of the launched application to the Internet if the application is a .Net or web programs like (yahoo chat programs, MSN messenger, Skype . . . ), and lastly, the AI will also keep track how-long has the program been installed in the user's digital device.

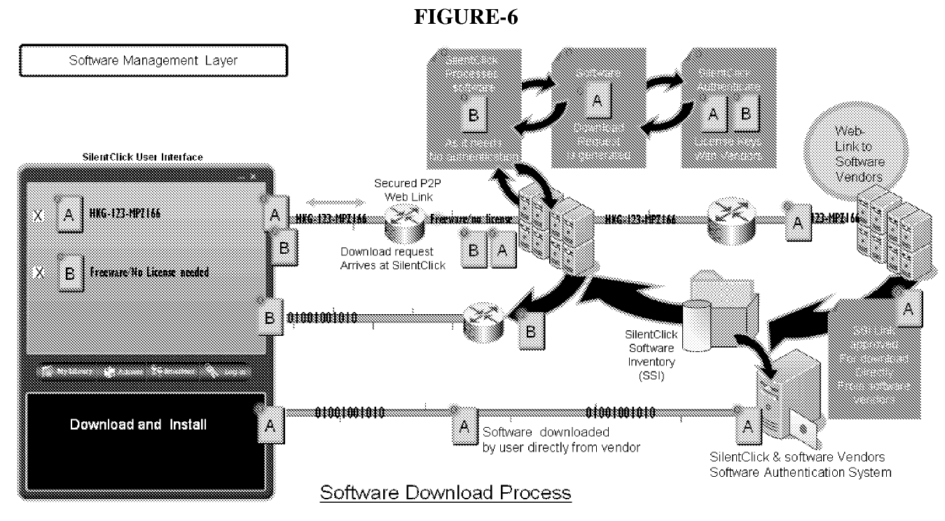

The present invention provides a method and system to effectively perform an over the Internet storage of software acquired on-line to the private communications network 2 executed via the Software Management Utility. As shown in FIG. 6, the software can be acquired directly from a software vendor 6 online and directly transferred over the Internet over private networks for storage to a private SilentClick communications network 2 associated with the user. In other words the user need not download the software from the vendor and then upload it to the SilentClick private communications networks, but may have it moved transparently directly from the vendor to the private SilentClick communications network 2 associated with the user. In other aspects the vendor may have the associated software on the private communications network 2 and the associated “transfer” for software acquisition by the user is only of the necessary authentication and access information to allow the user to access the previously stored software. Similarly, in another aspect the software may be stored directly at the vendor with the network maintaining appropriate authentication and access information for those users that have this software, and in this storage arrangement, new software acquisition by a user need only be the transfer of necessary authentication and access information for the new user.

The present invention provides a method and system to effectively perform an over the Internet automatic access to software vendors inventories in order for SilentClick to update its software inventory. The present method deals with a SilentClick web-search utility, a freeware software search engine or WebCrawler to keep its software inventory up to date and in order to reduce the upload latencies that might take place in the case of uploading entire software packages to SilentClick networks from the user's digital device, e.g. PC. The SilentClick software search engine works as follows. Once the user has installed SilentClick client software, the client software scans and builds a software table index which is then compared in real time with SilentClick software inventory. The user's software programs which matches SilentClick inventory are then linked automatically to the user's available library and SilentClick networks avoids the physical upload of the software. See FIG. 6. In the case that the software is not available, SilentClick deploys its software search engine to go and locate it. Once the software is located, the software is then deposited in SilentClick software inventory and is then linked to the user's available software table at SilentClick networks.

The present invention provides a method and system for a SilentClick WebCrawler and/or over the Web software search engine functionality. Again, see FIG. 6. The WebCrawler is an automatic self run search engine. The WebCrawler engine is given, in a look-up table, a set of names of all domains and or website addresses of software vendors who provide and allow for the download of free software. This look-up table is and can be updated to include other types of software. In a step (a) the WebCrawler then accesses the Internet and searches for the website in question and loads its main page in the computer's physical memory. The WebCrawler then scans the software vendor's main page to locate the search input field. Once the search input field is located, the WebCrawler then automatically inputs the name of the software to be searched for and triggers the search event process. In this case, the name(s) of the software(s) the WebCrawler is going to conduct the search for are those that SilentClick networks does not have available in its inventory after a scan and compare against the user's available software table list inside his/her digital device. In a step (b), after the search process is complete in step (a), the results of the search are then loaded into the computer's physical memory. Now the SilentClick WebCrawler search engine performs another scan to match the name of the software looked for exactly against the many possible results the search engine has returned. Once the exact match has occurred, the WebCrawler then automatically triggers the download of the software and adds it automatically to SilentClick networks inventory and now the missing link is closed. The recent or newly added software is then linked to the user's software table and is made available. Now, SilentClick networks can forego physically uploading the user's entire software(s) thus saving valuable storage space as well as time.

The method for obtaining the software list from the users is as follows. SilentClick's application scans the user's hard drive and captures all freeware and shareware applications. SilentClick then accesses in a transparent manner the vendor's software program vault via SilentClick's web search utility or WebCrawler, and conducts a search. Where the SilentClick WebCrawler engine finds the freeware or shareware programs inside the vendor's software program vault which matches the user's programs, SilentClick flags the user's programs as available and stores the linking pointer to these files on SilentClick's data base storage. See FIG. 6. This method and system eliminates the need to upload all the user's programs. The user clicks on “Upload All Programs”. SilentClick then tracks the user's programs and makes them available to the user for access at anytime and anywhere over the Internet. This method and system is fast and storage efficient as it eliminates the need to upload programs which already exist in the SilentClick Library vault and/or freeware and shareware vendors who are collaborating with SilentClick.

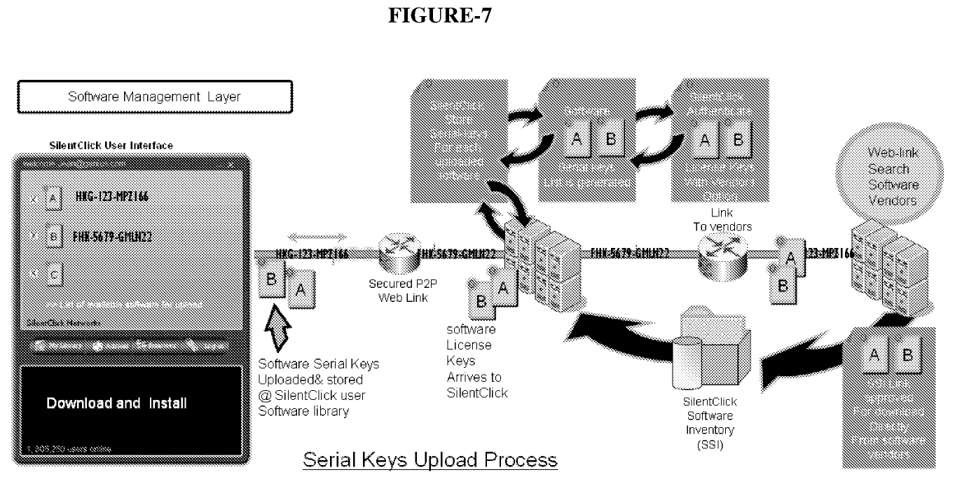

The same process for managing freeware and shareware also applies for purchased, licensed and downloaded software. SilentClick WebCrawler search utility points to and gains access to the software vendor's software program vault (depending upon the alliance established). SilentClick will then supply to the software vendor(s), the user's software license authentication key for software authentication to validate the user which then triggers the download and install directly from the software vendors' software program library to the user's digital device(s), as illustrated in FIG. 7.

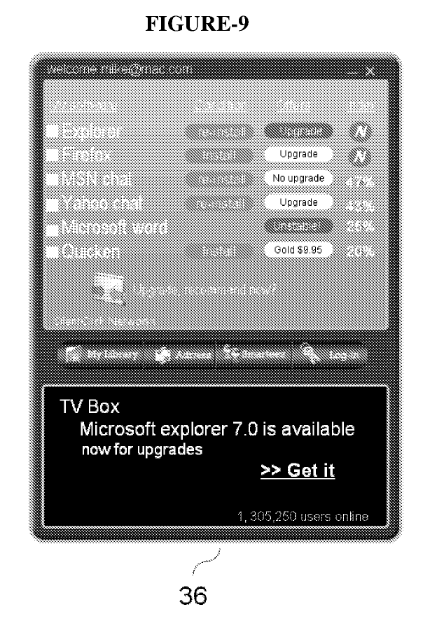

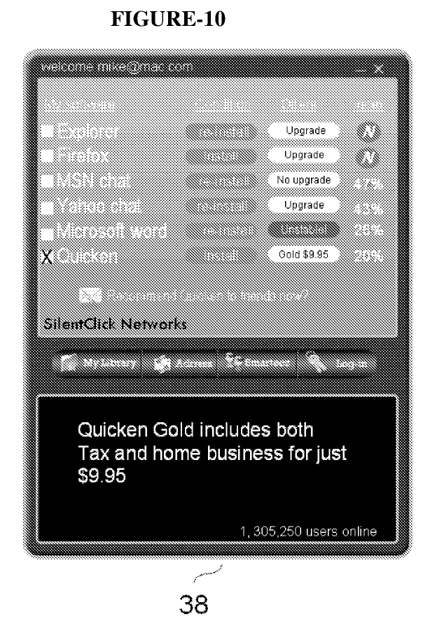

The present invention also provides a method and system for keeping the user informed of the latest software updates, upgrades and fixes without using email i.e. Microsoft Outlook and other email platforms. See for example GUI 36 illustrated in FIG. 9 or GUI 38 illustrated in FIG. 10. SilentClick networks alerts the user of such updates, upgrades and fixes via his/her SilentClick personal software organizer utility resident in his/her digital device (while connected to the Internet securely to SilentClick private networks) about any new software updates, fixes and promotions including special deals and reduced price offerings. The user will be able to get new software updates alerts discreetly through his/her SilentClick application program running on his/her digital device. The new software alerts are and will be strictly related to those software programs in the library the user has stored at SilentClick networks. No outside or non-related software alerts will be allowed to pass and thus no SPAM can access the user's SilentClick personal software utility manager resident in his/her digital device regarding other software. The way the user will interact with SilentClick software utility's Graphical Interface or User Interface application is as follows.

SilentClick Networks' software inventory manager maintains an indexed table of all available software in its inventory loaded in the computer server memory. SilentClick networks software inventory monitors and manages any newly added software updates and/or any new software version releases added to the inventory (see FIG. 9) as well as any software sales promotions (see FIG. 10). If and when a new piece of software is added to SilentClick software inventory, SilentClick software inventory indexed table is then loaded into memory and the newly added software is compared against each user's software library stored securely with SilentClick Networks. If and when the user's software library table shows that one of the software(s) is older than what SilentClick software index table shows, SilentClick networks then provides a software alert to the user or users which manifests in the following ways. Text will change on the user interface next to the software(s) application in question from ‘no updates’ to ‘update available now’ or a simple “upgrade” as illustrated in FIG. 9. Once the user moves his/her mouse on top of the text, details summary message regarding the new software update will be displayed on a TV live box area in the user's application graphical interface (see Table 1 below). If the user decides to update to the new software release he/she just clicks on the text itself or on the button located in the TV live box which states the action of download and install.

Another form of alerts SilentClick sends and also appears in the user's SilentClick graphical interface are software upgrade sales promotions. The user will be able to see the special price text message next to the software application. Once the user moves his/her mouse over the text, details summary message regarding the software promotion will be displayed on a TV live box area. See FIG. 10 for example. The user will be able to act on the purchase and the download, upgrade of the software by acting on the text and/or button indicating the trigger of the purchase and download. The software just purchased is stored directly with SilentClick networks as well as the license-keys and serial numbers associated with the software. The user's software library table is updated at SilentClick networks and the recently acquired software will be available to the user, anytime, anywhere in the world when connected to the Internet to SilentClick networks.

Thus, to recap, the present invention provides a One Click Button software Install method and system, describing a process over the Internet which allows the user(s) to gain access to their private, over the web hosted, pool of software via the Software Management Utility.

The present invention also provides a One Button Software Serial Numbers Authentication method and system, describing a process over the Internet which allows the user(s) to gain access to their private, over the web hosted, pool of software via the Software Management Utility during software installation and be able to through a One Button Serial Number authentication to have all the software that is targeted for install have their matching serial numbers authenticated.

The present invention provides a method and system that renders the software applications management, hosted over the web, manageable over the Internet.

Another aspect of the present invention is that it provides a method and system allowing the user to gain access to multiple software vendors' network.

The present invention also provides a method and system allowing the user(s) to gain access to their software library over the network.

The present invention provides a method and system allowing the user(s) to gain access to their, over the web hosted, software library and be able to perform one or more software application installs via the Internet to a digital device(s) such as PCs and the like.

In a preferred embodiment, the present invention provides such a method and system for allowing the user(s) to gain access to their over the web hosted software library and be able to perform multiple, and simultaneous, software applications installs over the Internet with only using one click of the mouse. This one button click or one click of the mouse to install a software program or perform multiple and simultaneous software installations only requires the user to select from his/her software library the programs he/ she is wanting to install. Once the user triggers or performs the one button click to begin the “install All” selected programs, from that instance onwards, the user need not to interfere again or interact with the installation of all the programs selected for installation. This is a completely novel feature of that of the prior art where a user had to input command after command when reinstalling software programs that had crashed or otherwise required re-installation. SilentClick technology allows for “silent” (here meaning via a one click or via very limited user input) installation of all programs chosen by the user with little or no further interaction from the user. All programs are installed silently because the inputs originally required to install the programs have been previously recorded and indexed by the SilentClick upload engine and the artificial intelligence engine. One methodology and technology that may be employed to record and index the original installation prompts may include the use of frame sequence overlays. The SilentClick upload engine assumes that all of the previous software installation prompts screens and events recorded during installations were correct, and the input from the user is simply streamed back transparently during the re-installation of the software for the second time, allowing the software to install without intervention of the user and thus the term “SilentClick.”

The present invention provides a method and system allowing the user(s) to gain access to their, over the web hosted, software library and be able to perform a single software application install over the Internet to a Digital Device(s).

The present invention provides, in association with a single over the Internet software application install, a Software Authentication System and Method associated with matching the single software targeted for install over the Internet with the matching serial number.

The present invention provides a method and system allowing the user(s) to gain access to their, over the web hosted, software library over the Internet and be able to perform multiple and simultaneous software applications installs over the Internet to a Digital Device(s).

The present invention provides, in association with the multiple and simultaneous software install, a Simultaneous Multiple Software Authentication system and method associated with matching simultaneously multiple software applications targeted for install over the Internet to their matching serial numbers during the installation process to a Digital Device(s).

The present invention provides a method and system allowing the user(s) during the process of acquiring a software application(s) over the Internet the access to their, over the web hosted, software library over the Internet and be able to perform a single software application Install via the Internet to a Digital Device(s).

The present invention provides, in association with a single or multiple software application install(s) and in association with the Single or Multiple Software Serial Number Matching Authentication Method and System, wherein the software management utility performs a single or multiple application “vendors-to-client” software install(s) during the install to a Digital Device(s).

The present invention provides a “One Time Install and Destroy” Method and System allowing the user(s) to gain access to their software library and be able to perform a single or multiple software application install(s) over the Internet to a Digital Device(s). The user(s) may gain access to their software library and be able to perform a multiple, and simultaneous, software applications install(s) over the Internet via the private network(s).

The present invention provides a method and system for a one time multiple personal software installations and use authentication.

The present invention provides a method and system allowing the user(s) to gain access over the Internet to their online software library and be able to perform a one click software Downgrade(s). It has been known that sometimes people rush to upgrade online to newer software releases and sometimes fall victim to software bugs that have not yet been cleared. This SilentClick utility will allow users to fall back to previously known good working releases the user has stored. The SilentClick one click downgrade will automatically un-install the most recent software upgrade and will install a previous known release the user will select. In the case of the software needs no license Key authentication and or is free as in freeware or shareware or is a trial release version, SilentClick will not seek to authenticate the software subject matter and will proceed to fulfill the user's request by authorizing the download directly from SilentClick software inventory (“SSI”). In the event that the software requires authentication, SilentClick will then seek to authenticate the software License Keys by requesting online to access the software vendor(s) authentication user software authentication database. Once the software subject matter's license-Keys are approved, the software download will be granted to the user and SilentClick will stream and overly the software prompts screens data inputs which are stored with-in SilentClick user library and the software downgrade will take place transparently.

### The Software Performance Index Layer

The present invention also provides a software performance ranking system which will yield a software index or score to all the software(s) that the user has installed in his/her digital device(s). Unlike other software ranking systems which are based on the number of downloads for each software application and user's feed back, SilentClick rating index is based on actual real time computational performances of the software(s) use and stability over time.

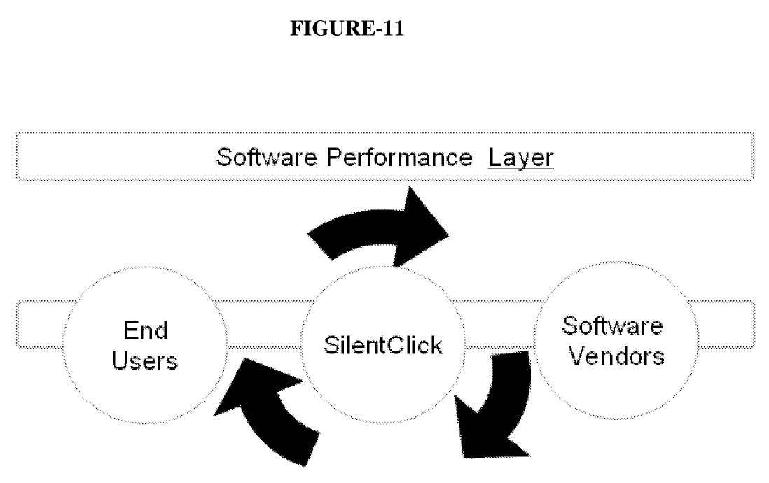

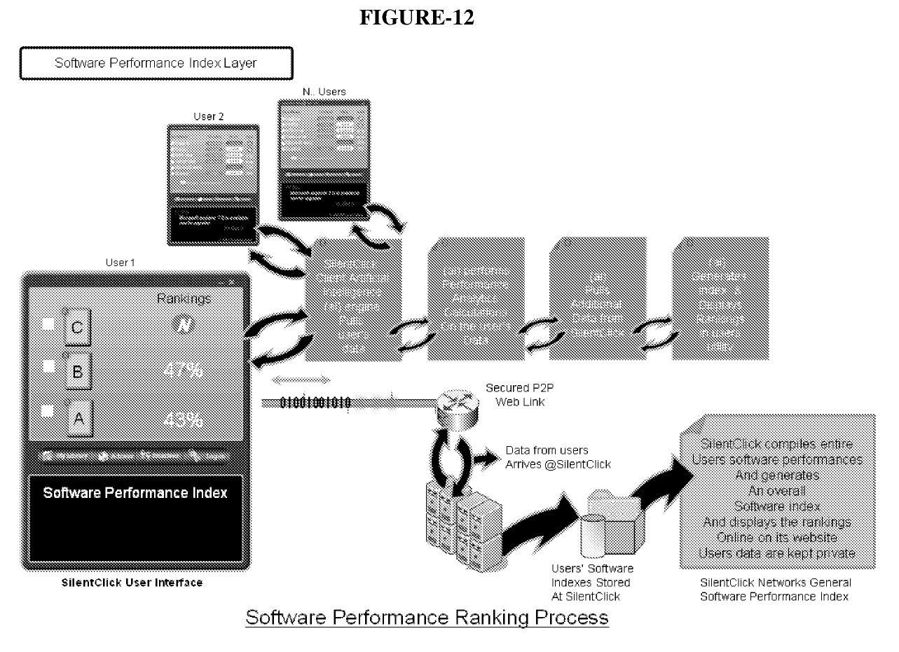

Referring now to FIGS. 11 and 12, there is shown the SilentClick software ranking index system which is based on generating a software performance and utilization index during the life cycle of the software being installed inside the user(s) digital device. Each time the user logs-in over the Internet to SilentClick private networks, the software(s) performance ranking indexes are captured, then are uploaded and stored in the user's software usability index table for later use by SilentClick. This update occurs each time the user logs-in to SilentClick. The present software ranking system and invention is based on recalling and compiling the data that the SilentClick artificial intelligence has been able to gather and store in the user's software table index. The user's data is loaded into the computer physical memory which includes but is not limited to: data on the time since the software has been installed in the user's machine; data on how many times the software session has been run or opened; data on the duration of the opened session each time the software was opened and or logged in to the internet in the case the application was an online software program session, data on the number of times the software was triggered to open a session or to be launched but yielding no openings of any session as a result; data on how many times the software has been installed and how many times it has been removed from the digital device, each time the software has been installed in the case of hard drive crash. SilentClick software management utility captures and compiles the list of data and derives a mathematical equation which results in a final number or index for each software running inside the user's digital device. The SilentClick software management utility performance ranking index processes the data as follows. It will track each time a software application is installed; and or is uninstalled; and or is removed and deleted from the software library.

More particularly, the process is as follows:
1. SilentClick Client software is installed that contains AI
2. AI retrieves and sorts data
3. AI computes data and generates the Index
4. The software performance Index is displayed
5. Software performance data is stored with SilentClick.

Data used to generate the Index include but are not limited to:
(L), The software that exists in the user library
(T), time since the software was installed in user Digital Device
(D), software that was uninstalled from user digital Device
(S), StmartieZ logic states
   Number of times the software was recommended to a recipient and the recipient has acted on it by installing the recommended software.
   Number of times the software was recommended to a recipient and the recipient has acted on it by accepting the recommendation but not installing the software.
   Number of times the software was recommended to a recipient and the recipient has refused the software recommendation.
   No recommendations about the Software were Ever made
(U), User personal software ranking i.e. [0 . . . 4]
(ND), the number of times the software was Uninstalled from digital Device
(A), SilentClick networks' generated value
(ND)/(T) for software stability over a period of time. As shown below in Table 1, these factors are provided in an equation used to calculate the index.

TABLE 1

| Variables | Type | Best | Worst | Value | |
|---|---|---|---|---|---|
| L | Boolean | 1 | 0 | [0, 1] | |
| T | Integer | 5 | 1 | [1, 2, 3, 4, 5] | classe that represent |
| D | Boolean | 0 | 1 | [0, 1] | the degree of use or |
| | | | | | time of life |
| S | Integer | 3 | 0 | [1, 2, 3] | |
| ND/T | Real | 4 | 0 | [0, 1, 2, 3, 4] | |
| U | Integer | 4 | 0 | [0, 1, 2, 3, 4] | |
| ND | Integer | 0 | 4 | [0, 1, 2, 3, 4] | classe that |
| A | Real+ | | | [0, . . ., 10] | represents stability |
| | | | | | of software witch |
| | | | | | is relatif to (T) |

f(soft) −= f(L, T, D, . . .,A)

| Domain of definition of the function f( ) | Type | Value |
|---|---|---|
| | Real | [0, . . . 100] |

* If f(soft) >= 90 then the Soft is Nooga
* f should grow depending on the quality of the soft

| f(L, T, D, . . .,A) = D * A * g(L,ND/T,S,U) | | value between 0 and 100 |
|---|---|---|
| | A between 0 and 10 | |
| | g( ) between 0 and 100 | with <=f( ) <= 100 |
| | Equation is : | |

f(soft) = D * A * U(5 * L+4 * (ND/T)+3 * S)

In one non-limiting aspect of the present invention, the Software Management Utility will compile the software rankings of each user and will generate an over all performance ranking index about all the software that the users have installed in their digital device(s). The user's software data the AI has captured is loaded and stored ion the user's software management table index when the user(s) has logged in to the SilentClick private networks. All final software(s) numbers are ranked and are displayed in a descending order for the user(s) to see.

### The Software Disaster and Recovery Software Layer

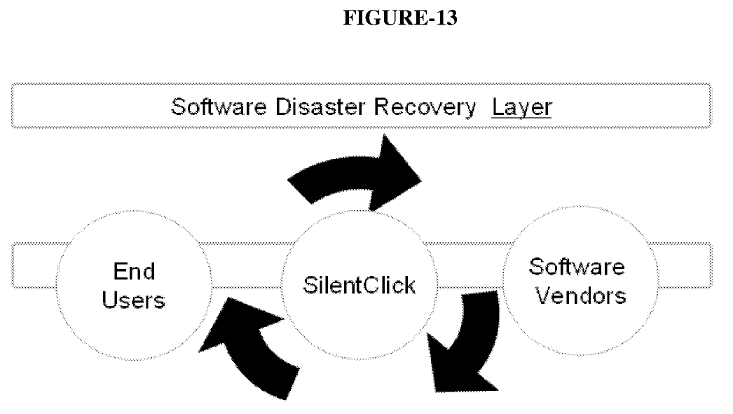

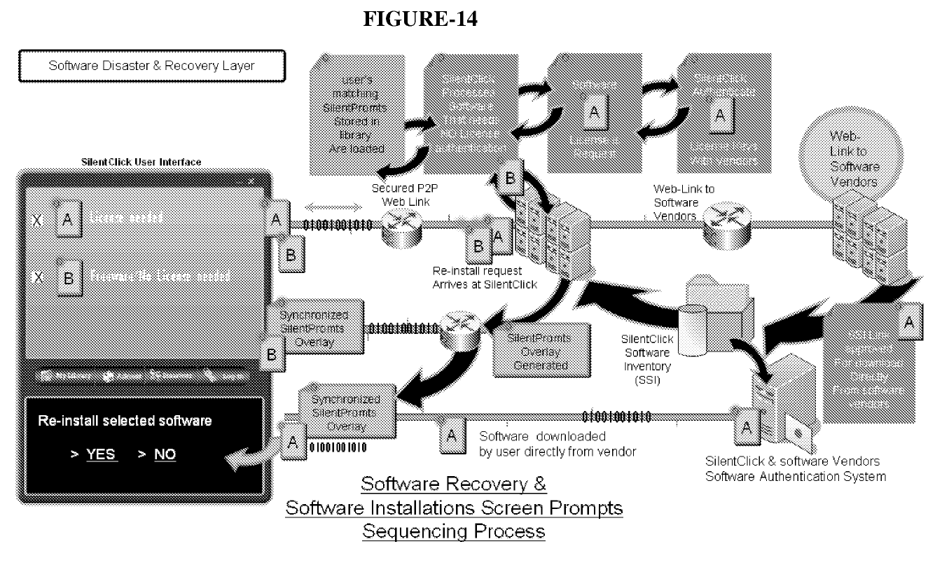

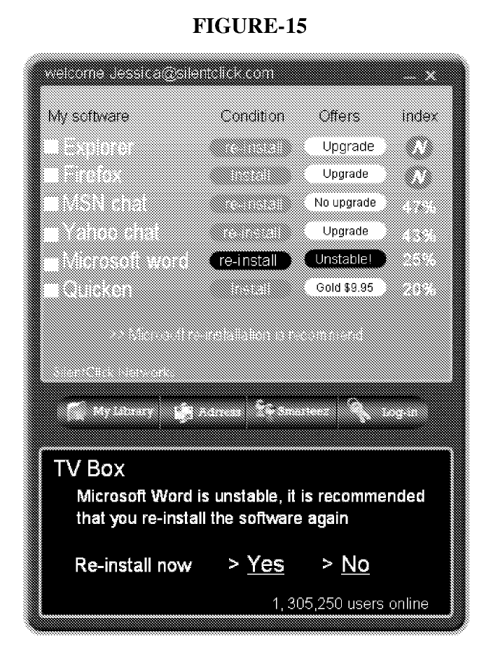

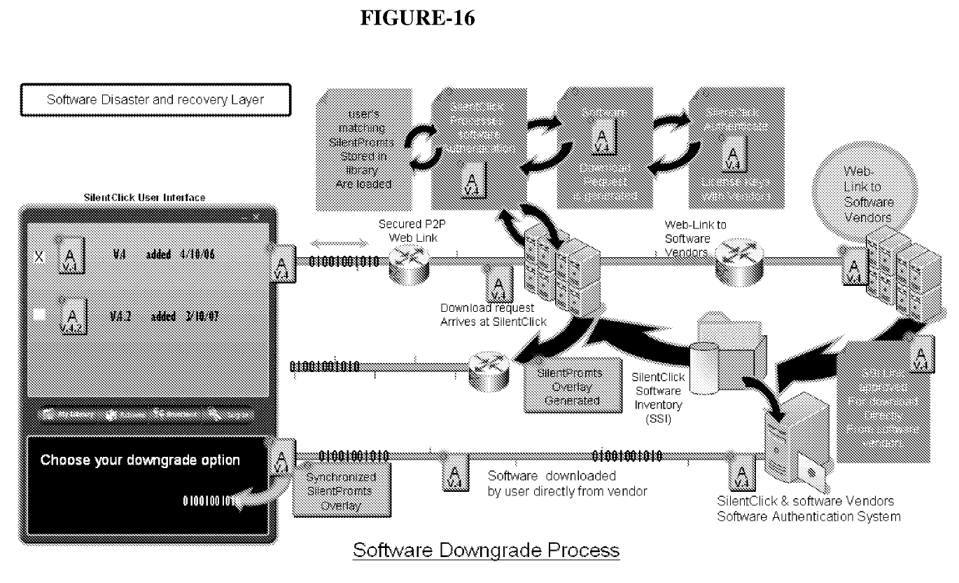

The present invention provides a method and system allowing the user(s) to receive alerts when a particular(s) software program is malfunctioning. Referring now to FIGS. 13, 14, 15 and 16, the software utility provides for the software disaster and recovery layer to push alert messages to the user(s) requesting for actions to take place to fix a particular problem(s), as shown in FIG. 16. Examples include but are not limited to software deleted or otherwise removed by accident, corrupted application software, accidental or otherwise improper deletion of one or more shared DLL files when uninstalling or removing a software program, Virus attacks damaging the software application, etc. Whether any of the foregoing causes or combinations of them or other causes have rendered the application software “Unstable”, if the user wishes to fix the current “Unstable” alert displayed in the user's interface to a normal and functional state, the user simply needs to click install and/or re-install and the software will be downloaded and installed using the above described SilentClick one click install techniques. The installation and/or repair is then conducted discreetly without the user's intervention.

The present invention provides a method and system allowing the user(s) to downgrade his/her particular(s) software version program to a previous release of his/her choice presented to them in their library as an option. Referring now to FIG. 16, the software utility provides for the software disaster and recovery layer a one click install and/or downgrade to a previous version(s) or any available software revision option(s) the user may choose. Software utility will allow for the download and installation of a particular software application using SilentPromts or synchronized screen prompts.

### Software Publishing Layer

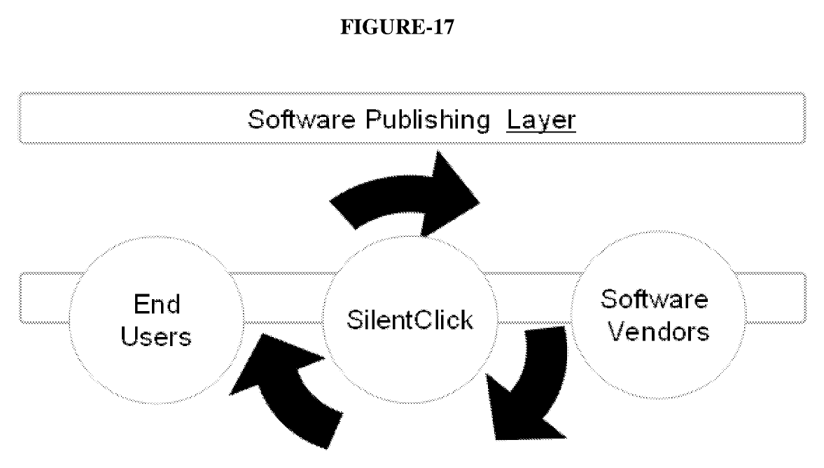

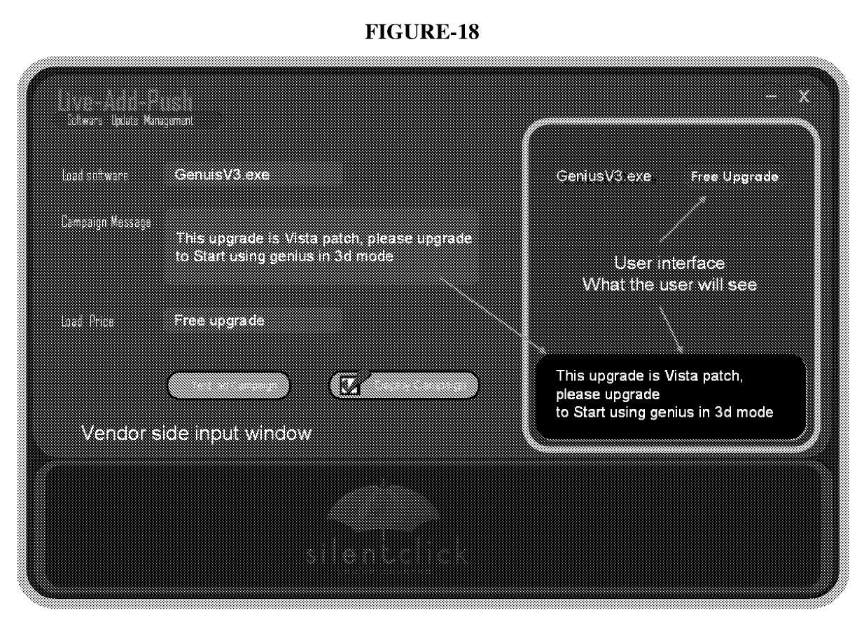

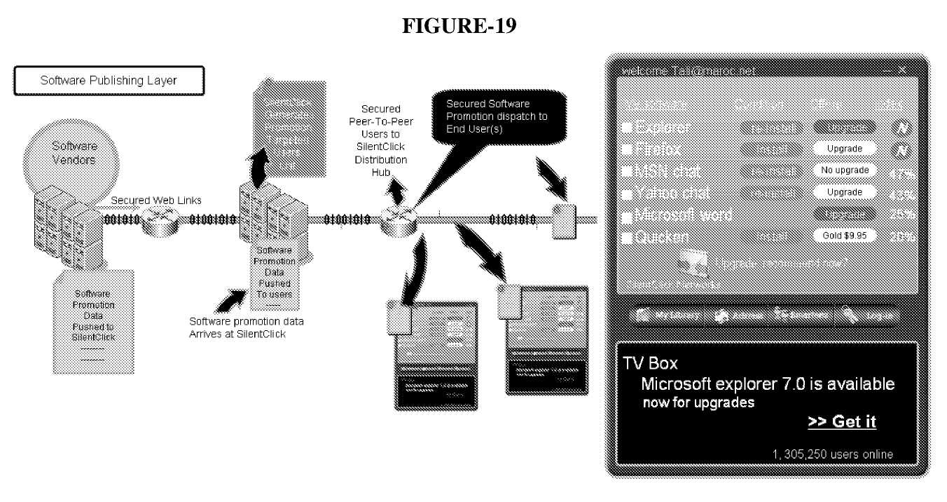

With the SilentClick vendors-to-customers software utility as illustrated in FIGS. 17, 18 and 19, the software vendor will send their special add promotion about their offerings. These ads will show up on the user's SilentClick personal software utility. In the past, the software vendors had to email their current users the software promotions via emails, or mailed CD's. In some cases the users then had to open their email, read through, and then open the email from the software vendor. They then had to click on the link to route them to the vendor's website. The users then had to search to find the program on the vendors' website, and then download it. After the download they have to install it.

With the SilentClick vendors-to-customers utility, the ad and or promotion appears on the user's personal software utility. The user then only needs to perform one click of the mouse to begin installation. There is no need for the user to go through all the above mentioned processes of the past. In an alternative embodiment, the present invention provides a method and system for software vendors to send direct software advertisements and offerings to their current software programs users via SilentClick peer-to-peer network connections and SilentClick user's personal software management utility. Traditionally, either the user has to go to software vendors' websites or must receive in his/her mail box an email message in order to be made aware of any updates, fixes or new programs as described above.

The present invention presents a method and system for a direct link utility that will connect software vendors-to-customer with their customers. This SilentClick vendors-to-customer utility will give software vendors a direct link, e.g. a Peer-to-Peer link over the Internet directly to their customers via SilentClick networks and SilentClick software management utility the users are running inside their digital device. No transfer of actual software itself will occur between the vendors and their customers. SilentClick inventory holds one copy of the actual software to be installed that eventually customers will download once they receive their software alert(s) from the software vendors via SilentClick networks once the user's digital device is connected online.

In yet another embodiment of the present invention, the present method and system provides a software utility that allows software vendors to push content, i.e. upgrade, fixes, promotions directly to their customers via the SilentClick peer-to-peer network connections by-passing emails, (i.e. Microsoft outlook and others email messages systems). A SilentClick vendors-to-customer content push utility allows software vendors to log-in securely over the Internet to the SilentClick main website. Software vendors have the opportunity to register and create their own personal account. Once the account is set up, software vendors are able to create a list of their available software by uploading their software into SilentClick software inventory. Once uploaded, the software vendors can view their entire software list and be able to select the particular software they want to let their customer know about or run a promotion on. Once the software vendor has selected the software they want to push, they are asked to enter precise text that will appear in the box i.e., upgrade to 5.0, Free for 30 days, $9.95 get it now . . . ). Once the text is entered, the software vendors will be asked to write a short description about this new promotion and the software so that when the user moves his/her mouse over the i.e., upgrade to 5.0, they will be able to see the description of the promotion displayed in the SilentClick TV-like information box. Once the software vendor has completed their promotion text content set up for the targeted software(s) securely inside SilentClick web site, and is/are ready to push it and or send it to their customers, all that is needed at this point is just to confirm the deployment by answer “Yes” to “Deploy now?”. Once the software vendors agree on the go ahead and push the promo, SilentClick networks software management utility loads the software targeted for promotion in to the computer physical memory and loads SilentClick entire software library index table into physical computer memory. The SilentClick software library index table contains the total number of people who own each copy of any software inside SilentClick software inventory. SilentClick software library index table also has pointers pointing to each user who owns that particular software that is targeted for promo. The users then who are targeted for this promotion are tagged or flagged as to be receiving the promotion message. SilentClick then pushes the prepared text promotion into each of its users SilentClick software utility who have been flagged or tagged. Each time the SilentClick software utility user connects to the Internet and to SilentClick networks, his/her SilentClick software manager utility will update to display the recent pushed content by the software vendors.

### The Software Social Network Layer

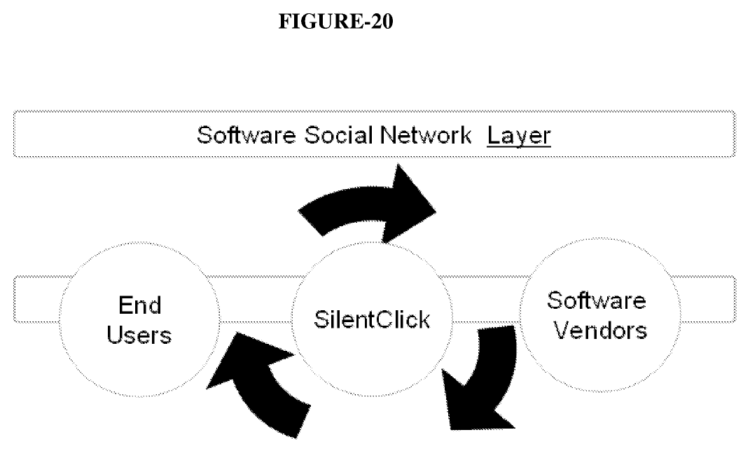

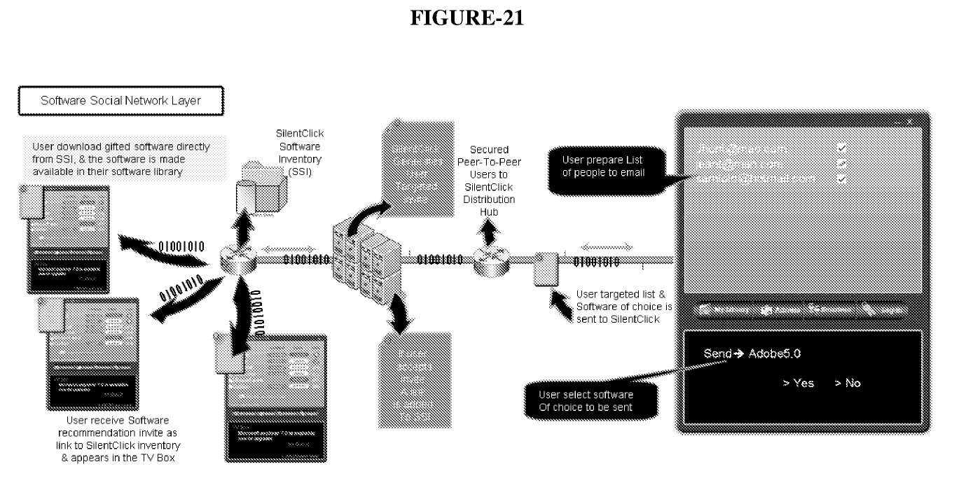

The present invention provides a method and system for a software social networking utility engine. Referring now to FIGS. 20 and 21, the utility will allow the user(s) to easily share their software favorites list, i.e. freeware, sharewares, free software and trial software with their friends, family and others with ease without having to physically send the actual software. SilentClick software social networking engine option is built-in as a feature inside SilentClick software management utility. The software management utility allows users to build their friends, family and others address book. Through their personal SilentClick software utility, users can access their software library table stored at SilentClick via their digital device through SilentClick software utility and select the software(s) program(s) of their choice from that they would like to share or make recommendations.

The SilentClick social engine plug-in use model is designed to be simple. Once the software social engine is installed, the user's address book is scanned for all email addresses and once the scan is completed the user is presented with the option to add the addresses to his SilentClick address book. The user at this point need only select the program(s) for recommendation and the Internet email addresses which they will be automatically prompted to choose from. When the user sends the recommendation, no files are sent but only an email with name of sender and message “you have objects in your box”. For the user to retrieve the sent recommendations they are asked to sign up for the SilentClick service. Once the user has downloaded and installed SilentClick personal software management portal, once SilentClick' personal portal is launched, the user will be able to see the files that were recommended. He or she will have the choice to accept and start installation as no download is required. This social engine software recommendation process is fast, efficient and eliminates the huge transfer of files between software users, and storage requirement.

### The Software Transfer Layer

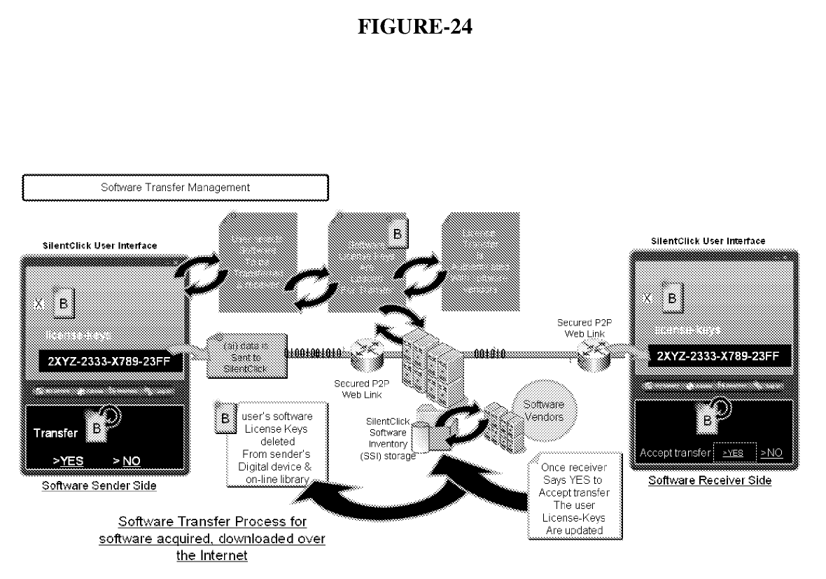

The present invention provides a method and system through SilentClick user's personal software portal for users to transfer programs they no longer need or use. The end user license agreement (“EULA”) of certain Microsoft Corporation software, for example, states that a user can make a one time transfer in a life time of the software which they have licensed from Microsoft Corporation. SilentClick allows its users to perform such tasks monetarily or for free at the discretion of the users. Once the user decides to make the transfer, all that needs to be done is to recommend the software to whomever the user has chosen on the email recommendation list. SilentClick will deploy the install and destroy feature forwarding, or using the recommending feature including, where necessary, sending the transfer of the software license key to the recipient of the software. The recipient will get a message in his or her personal software portal and have the option of accepting the software sent. If accepted, the new program will show up in the recipient's program list, as will the license-key. The License-key will be removed from the sender's digital device and sender's on-line software library will be updated accordingly. See FIGS. 20, 21 and 24 for example.

### Mobile Software Utility Management

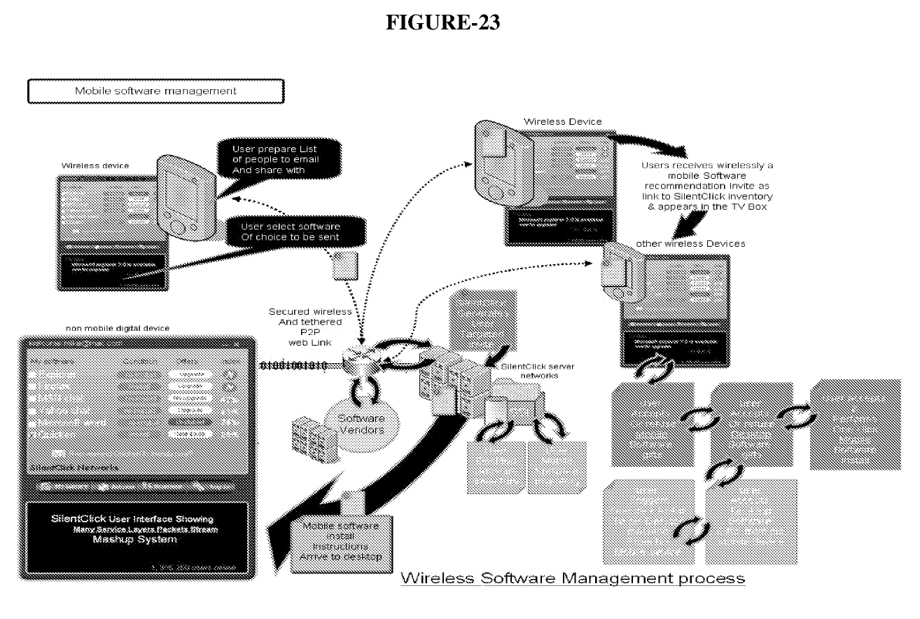

The present invention provides a method and system through SilentClick software utility to manage mobile software as illustrated in FIG. 23. SilentClick uses the same desktop platform strategy to address the mobile digital device software management. SilentClick networks server software management utility structures its user's software inventory into device specific software platforms. (i.e. will store software targeted for the desktop application, software targeted for mobile applications, set-top-box and so on . . . )

The present invention also provides a method and system through SilentClick software utility to manage mobile-to-mobile software social network recommendation and installation management, also as illustrated in FIG. 23. SilentClick uses same method and systems used in software social network layer for addressing mobile-to-mobile software recommend to friends and family management.

The present invention also provides a method and system through SilentClick software utility to manage mobile-to-desktop software social network recommendation and installation management as illustrated in FIG. 23. Mobile digital device users can receive software recommendation related to their other related digital devices and can trigger installations.

Thus whether wireless and mobile, or non-mobile, the system and method of the present invention provides for comprehensive software management in the same fashion as described hereinabove with respect to the description of the PC or digital device applications for all digital devices, whether wireless or not.

### CONCLUSION

In summary, the present invention relates to a method and system for comprehensive software management. More particularly, the present invention is directed to a web based personal software access or portal system for application software storage, acquisition and management, as described herein.

Whereas particular embodiments of the invention have been described above for purposes of illustration, it will be evident to those skilled in the art that numerous variations of the details of the present invention may be made without departing from the spirit and scope of the present invention.

What is claimed is:

1. A comprehensive software storage and management system comprising a host network and an online software management application on the host network which allows a plurality of users to store and manage their software applications associated with the user's digital devices over a communications network, wherein the software management application will allow the user(s) to upload, download and install at least one of the user's individual software applications over the communications network, wherein the user's individual software applications collectively form the user's individual software library and wherein the comprehensive software storage and management system provides at least one of:
(i) a one button upload of new software applications from the user's electronic devices to the host network and into the user's individual software library,
(ii) a one button download and install of software applications in the individual software library from the host network to the users digital devices,
(iii) a one button transfer of software applications in the individual software library to another user's individual software library,
(iv) a one button downgrade of software applications in an individuals software library comprising the reversion within the user's individual software library to the previous known version of the selected software application, and
(v) an automatic software authentication of software applications in the individual software library for the users and/or vendors.

2. The comprehensive software storage and management system according to claim 1 further including a Peer-to-Peer layer constructed to allow users build lists of individual software applications form individual software libraries and share the list across the communications network with other users digital devices.

3. The comprehensive software storage and management system according to claim 1 further including a Peer-to-Peer software publishing layer configured for connecting software vendors with their clients that are users of the system.

4. The comprehensive software storage and management system according to claim 3 wherein the system is configured such that software vendors can offer users of the system with one click button at least one of software promotions, software upgrades, software fixes, special discounts, software viral spread engines and combinations thereof.

5. The comprehensive software storage and management system according to claim 1 further including ranking system of individual software applications on the host network and is complied to generate a software index for each software application.

6. The comprehensive software comprehensive software storage and management system according to claim 1 wherein the system uses a graphical interface for the users and forms a Peer-To-Peer connection between software vendors and the user's digital devices.

7. The comprehensive software storage and management system according to claim 1 wherein the host network will store a unique software application that is common to several user's software libraries, whereby each of the users having this unique software application in their software library will have access to the software application.

8. The comprehensive software storage and management system according to claim 1 wherein users are provided with a one button download of software applications in the users individual software libraries from the host network to the respective user's digital devices.

9. The comprehensive software storage and management system according to claim 8 wherein at least one software application that is stored on the host network is common to a plurality of users individual software libraries.

10. The comprehensive software comprehensive software storage and management system according to claim 1 wherein users are provided with a one button transfer of software selected from licensed software applications, non-licensed software applications, and combinations thereof that are in the user's individual software library to another user's individual software library.

11. The comprehensive software storage and management system according to claim 1 wherein users are provided with a one button upload of at least one software application from the user's digital device to the user's individual software library on the host network, and wherein users are provided with a one button download of software applications in the users individual software libraries from the host network to the respective user's digital devices.

12. The comprehensive software comprehensive software storage and management system according to claim 1 wherein the users are provided with a one button downgrade of software applications in a user's individual software library comprising the reversion within the user's individual software library to the previous known version of the selected software application.

13. The comprehensive software comprehensive software storage and management system according to claim 1 wherein the system provides for an automatic software authentication of software applications in the individual software library for the users and/or vendors.

14. The comprehensive software comprehensive software storage and management system according to claim 13 wherein at least one software application that is stored on the host network is common to a plurality of users individual software libraries.

15. A comprehensive software storage and management system comprising a host network and an online web2.0 software management application on the host network configured to be coupled to a plurality of users via the internet which allows the plurality of users to store and manage their software applications associated with the user's digital devices over the internet, wherein the software management application will allow the users to view, manage, upload, download and install at least one of the user's individual software applications over the internet, wherein the user's individual software applications collectively form the user's individual software library, wherein the collections of individual software libraries form a host library and wherein the comprehensive software storage and management system provides at least two of
(i) a one button upload of new software applications from the user's digital devices to the host network and into the user's individual software library,
(ii) a one button download and install of software applications in the individual software library from the host network to the users digital devices,
(iii) a one button transfer of software applications in the user's individual software library to another user's individual software library, and
(iv) a one button downgrade of software applications in a user's individual software library comprising the reversion within the user's individual software library to the previous known version of the selected software application.

16. The comprehensive software comprehensive software storage and management system according to claim 15 wherein at least one software application that is stored on the host network is common to a plurality of users individual software libraries.

17. The comprehensive software storage and management system according to claim 15 wherein the host library is reviewed upon uploading of software for an individual to determine if the software is already on the host network.

18. The comprehensive software storage and management system according to claim 15 wherein the host network will authorize the user and identify the user's digital device with each connection to the host network.

19. The comprehensive software storage and management system according to claim 15 wherein the system records and indexes the software installation input prompts inputted by the user for each software application the user installs in the user's digital device for future synchronized streaming during a software re-install.

20. The comprehensive software storage and management system according to claim 19 wherein the system streams and overlays those previously recorded screen forms input prompts of the user during the re-installation for each software installation the user is performing for the second or other additional time so that the user does not have to provide those inputs again.
